(19) United States
(12) Patent Application Publication
(10) Pub. No.: US 2026/0181625 A1
(43) Pub. Date: Jun. 25, 2026

(54) METHODS AND APPARATUS FOR REQUESTING RESOURCES FOR AIOT DEVICE TRANSMISSIONS

(71) Applicant: InterDigital Patent Holdings, Inc., Wilmington, DE (US)

(72) Inventors: Martino FREDA, Laval (CA); Jongwoo HONG, New York, NY (US); Paul MARINIER, Brossard (CA); Aata EL HAMSS, Laval (CA); Erdem BALA, East Meadow, NY (US); Remun KOIRALA, London (GB); Kevin WANUGA, Souderton, PA (US)

(73) Assignee: InterDigital Patent Holdings, Inc., Wilmington, DE (US)

(21) Appl. No.: 18/989,979

(22) Filed: Dec. 20, 2024

(51) Int. Cl. H04W 72/1263; H04L 1/08

(52) U.S. Cl. CPC H04W 72/1263; H04L 1/08

(57) ABSTRACT

A WTRU includes a transceiver and a processor, which receive a configuration, from a base station, of periodic resources for transmissions with AIOT devices and a threshold. The processor and the transceiver transmit an occasion start message, to the AIOT devices, on one of the periodic resources and receive, in response, a first set of transmissions from each AIOT device in a set of AIOT devices. The first set of transmissions includes an initial transmission and at least one repetition of the initial transmission from the same AIOT device. The transceiver and the processor send a second transmission to a subset of the set of AIOT devices and transmit a resource request, to the base station, based on a total number of all repetitions of the first transmission from all of the AIOT devices in the subset, since a last transmission of a resource request, exceeding the threshold.

### BACKGROUND

Internet-of-Things (IoT) has attracted attention in the wireless communication world, and more and more “things” are expected to be interconnected for improving productivity efficiency and increasing comforts of life. In fact, further reduction of size, complexity, and power consumption of IoT devices can enable the deployment of tens or even hundreds of billions of IoT devices for various applications and provide added value across the entire value chain. It is, however, impossible to power all the IoT devices by a battery that would typically need to be replaced or recharged manually, which leads to high maintenance cost, serious environmental issues, and even safety hazards for some use cases, such as wireless sensors in the electric power and petroleum industry.

While energy harvesting could, in theory, be used to power such devices, the output power of an energy harvester is typically from 1 μW to a few hundreds of μW. Considering the limited size and complexity required by practical applications for batteryless devices with no energy storage capability, or devices with limited energy storage that do not need to be replaced or recharged manually, existing cellular devices may not work well with energy harvesting due to their peak power consumption of higher than 10 mW.

### SUMMARY

A WTRU includes a transceiver and a processor, which receive a configuration, from a base station, of periodic resources for transmissions with AIOT devices and a threshold. The processor and the transceiver transmit an occasion start message, to the AIOT devices, on one of the periodic resources and receive, in response, a first set of transmissions from each AIOT device in a set of AIOT devices. The first set of transmissions includes an initial transmission and at least one repetition of the initial transmission from the same AIOT device. The transceiver and the processor send a second transmission to a subset of the set of AIOT devices and transmit a resource request, to the base station, based on a total number of all repetitions of the first transmission from all of the AIOT devices in the subset, since a last transmission of a resource request, exceeding the threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal diagram of an example inventory procedure for radio frequency identification (RFID);

FIG. 3 is a signal diagram of an example inventory procedure for AIOT;

FIG. 4A is a system diagram of an example Topology 1 AIOT system;

FIG. 4B is a system diagram of an example Topology 2 AIOT system;

FIG. 4C is system diagram of an example Topology 3 AIOT system with downlink assistance;

FIG. 4D is a system diagram of an example Topology 3 AIOT system with uplink assistance;

FIG. 4E is a system diagram of an example Topology 4 AIOT system;

FIG. 5 is an example diagram showing Uu and AIOT resource allocations for an example AIOT inventory round;

FIG. 6 is a diagram showing Uu and AIOT resource allocations for another example AIOT inventory round; and

FIG. 7 is a flow diagram of an example method of requesting resources for AIOT transmissions.

### DETAILED DESCRIPTION

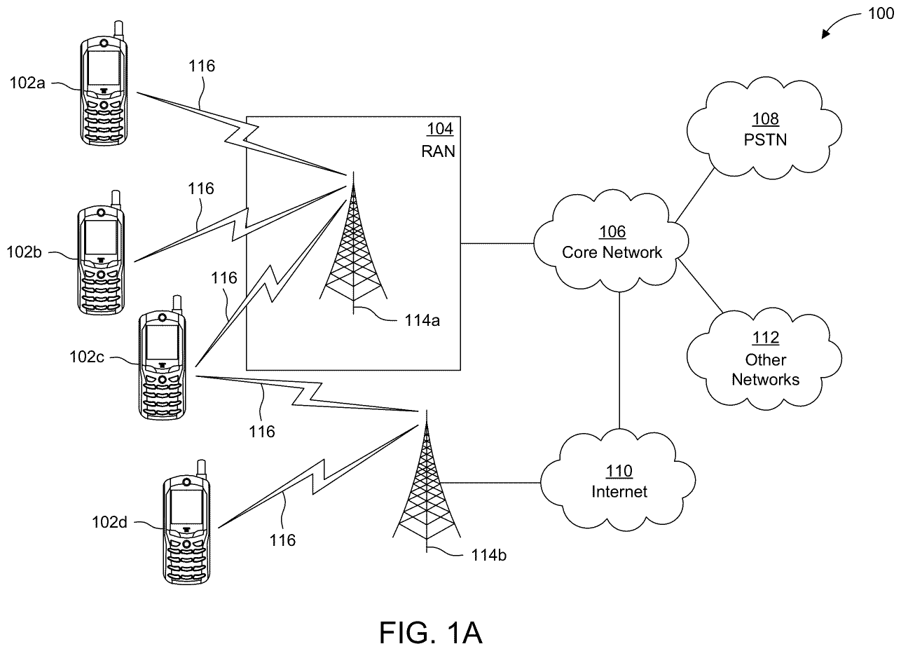

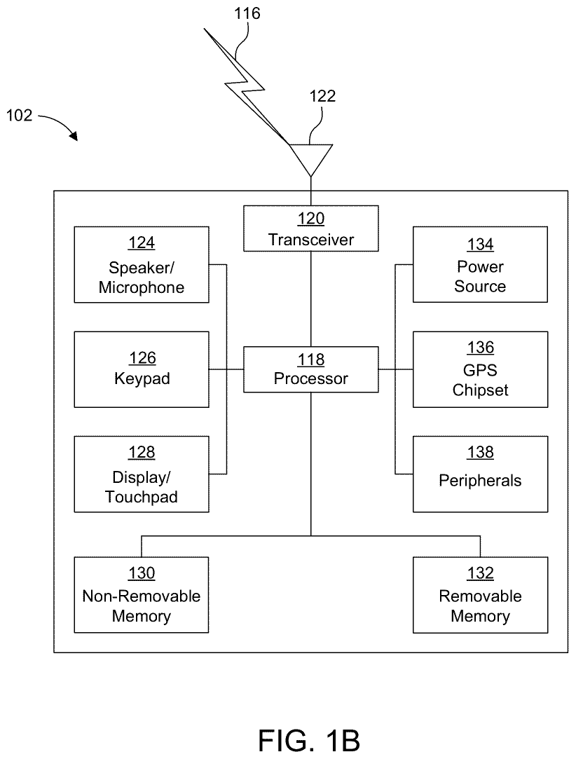

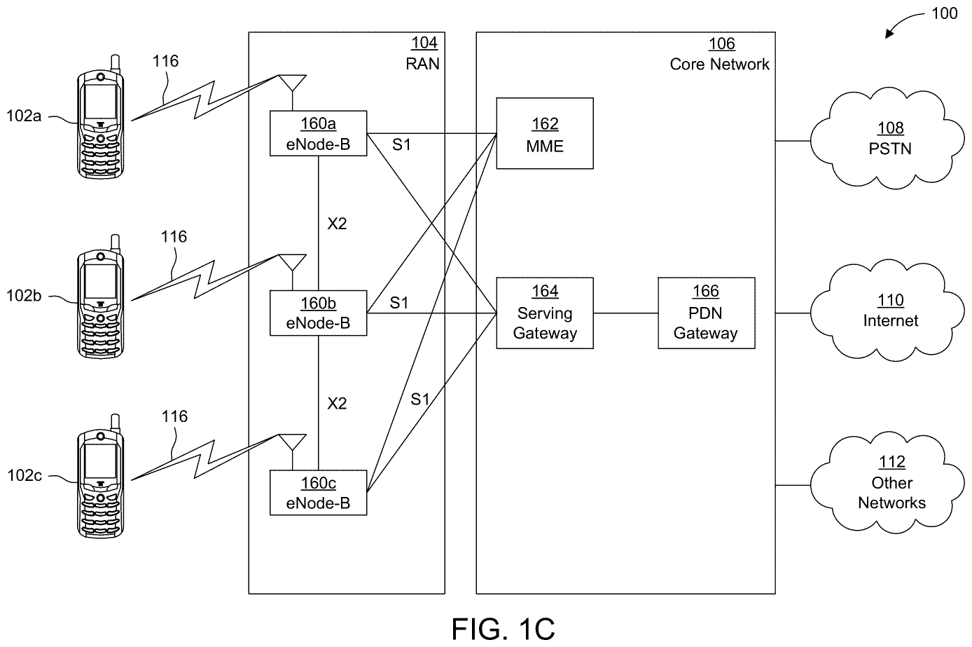

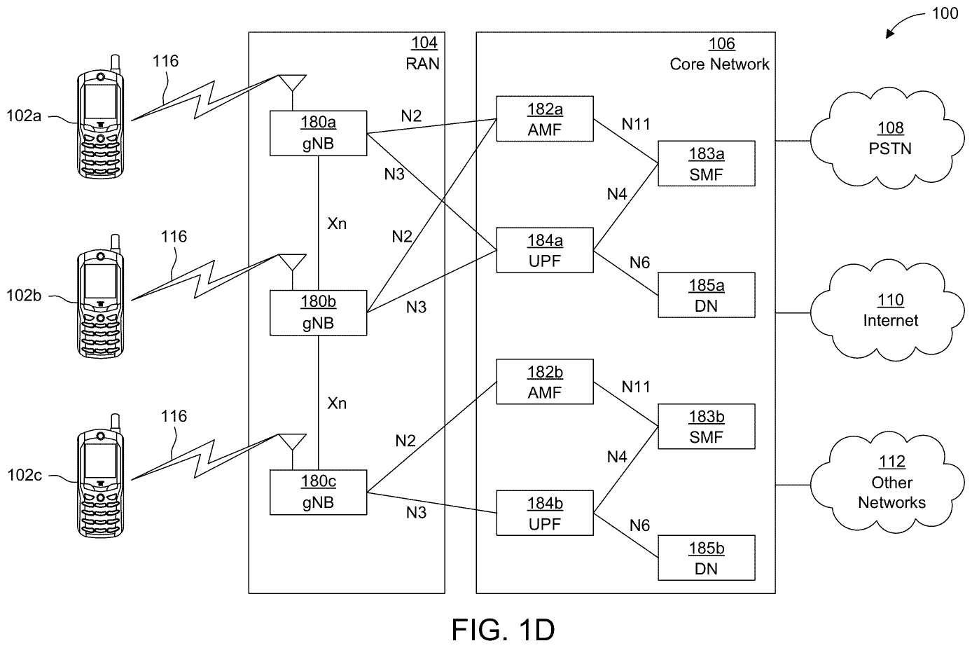

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102 c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180 a, 180 b, 180 c without also accessing other RANs (e.g., such as eNode-Bs 160a, 160b, 160c). In the standalone configuration, WTRUs 102 a, 102 b, 102 c may utilize one or more of gNBs 180 a, 180 b, 180 c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180 a, 180 b, 180 c while also communicating with/connecting to another RAN such as eNode-Bs 160a, 160b, 160c. For example, WTRUs 102 a, 102 b, 102 c may implement DC principles to communicate with one or more gNBs 180 a, 180 b, 180 c and one or more eNode-Bs 160a, 160b, 160c substantially simultaneously. In the non-standalone configuration, eNode-Bs 160a, 160b, 160c may serve as a mobility anchor for WTRUs 102 a, 102 b, 102 c and gNBs 180 a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182 a, 182 b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102 a-d, Base Station 114 a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

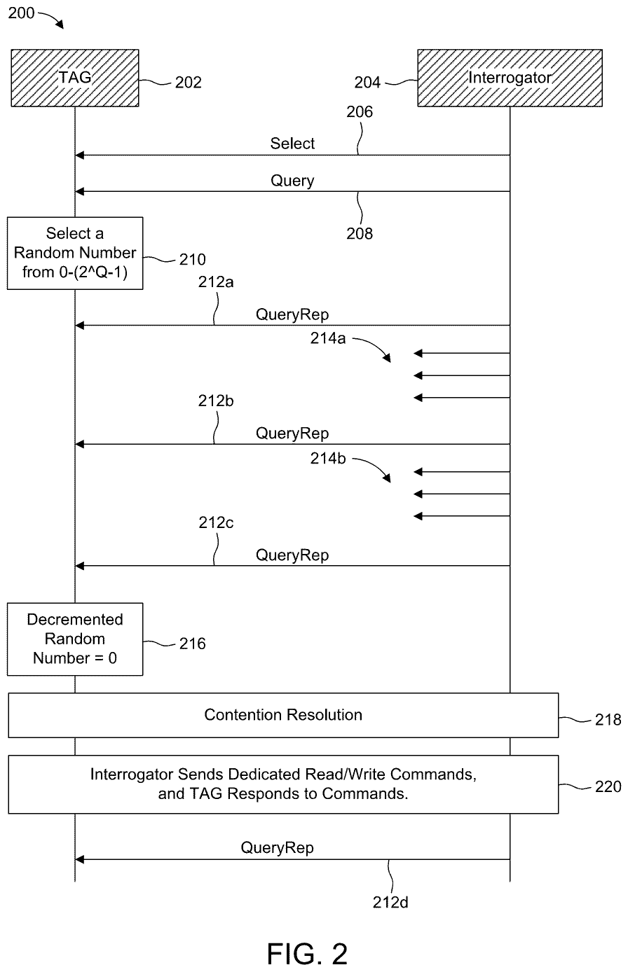

FIG. 2 is a signal diagram 200 of an example inventory procedure for radio frequency identification (RFID). RFID is conventionally used for asset identification applications. In the example illustrated in FIG. 2, an interrogator 204 (also referred to as an RFID reader) may begin each inventory round by sending a select message 206, which may be received by one or more RFID TAGS 202. The interrogator 204 may send a Query message 208 to energize all or a subset of the TAGs 202. Following the query message 208, a TAG 202 may select a random number from 0 to 2\hat{ }Q-1 (210) (where Q is a variable that can be configured by the network, for example, to define the number of time occasions in an inventory procedure and 2\hat{ }Q gives the number of access occasions). and load its memory with that number. The interrogator 204 may then begin sending a series of query reps 212a, 212b, 212c and 212d. At each transmission of a QueryRep, the TAG 202 may decrement its counter until the counter reaches 0. When the counter reaches 0 (216), the TAG 202 may initiate a contention resolution procedure (218), which may include the TAG 202 transmitting its device ID in the uplink and waiting for confirmation of the device ID in the downlink. This may be done to address possible collision between multiple devices selecting the same random number. For a device that has passed contention resolution, the interrogator can send multiple read/write commands, to which the TAG should respond. Dedicated read/write commands for specific TAGs are illustrated as 214a and 214b in FIG. 2.

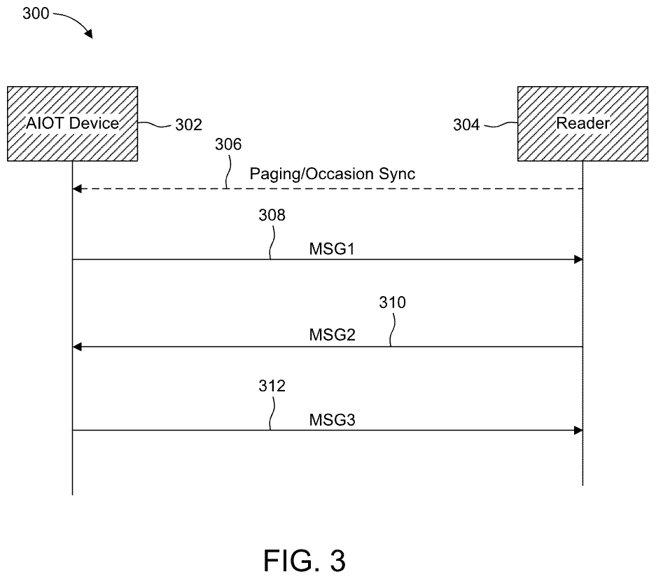

FIG. 3 is a signal diagram 300 of an example inventory procedure for AIOT. In the example illustrated in FIG. 3, the AIOT Reader 304 may be configured with periodic resources that may be used for the inventory procedure. In the example illustrated in FIG. 3, an AIOT Reader 304 may begin an inventory round by sending a message 306, which may be received by one or more AIOT devices 302. The message 306 may be, for example, a paging or occasion synchronization message, for example, and may signify the start of the inventory round. The AIOT Reader 304 may periodically send the message 306 using the configured periodic resources to collect data from the AIOT devices it is associated with.

Any AIOT device 302 that receives the message 306 may subsequently send a first message (MSG1) 308 in which the AIOT device 302 may include a random identifier (ID), which may be unique to the transmission from the AIOT device 302. If the reader receives the first message 308 from the AIOT device 302, it may send back a second message (MSG2) 310, which may include the random ID sent in the first message. The AIOT device 302 may then send back any data (e.g., application layer data) that it has to send to the AIOT reader 304 in a third message (MSG3) 312, which may also include the device ID of the transmitting AIOT device 302.

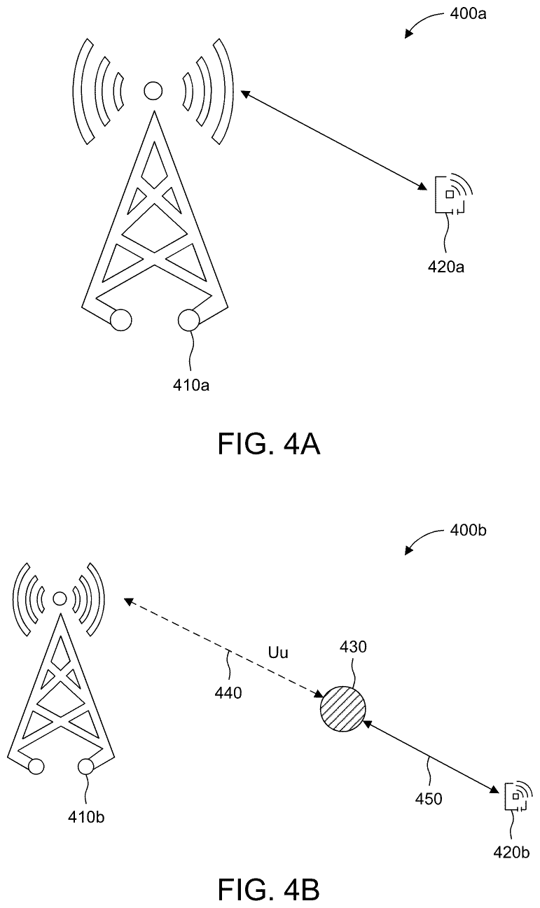

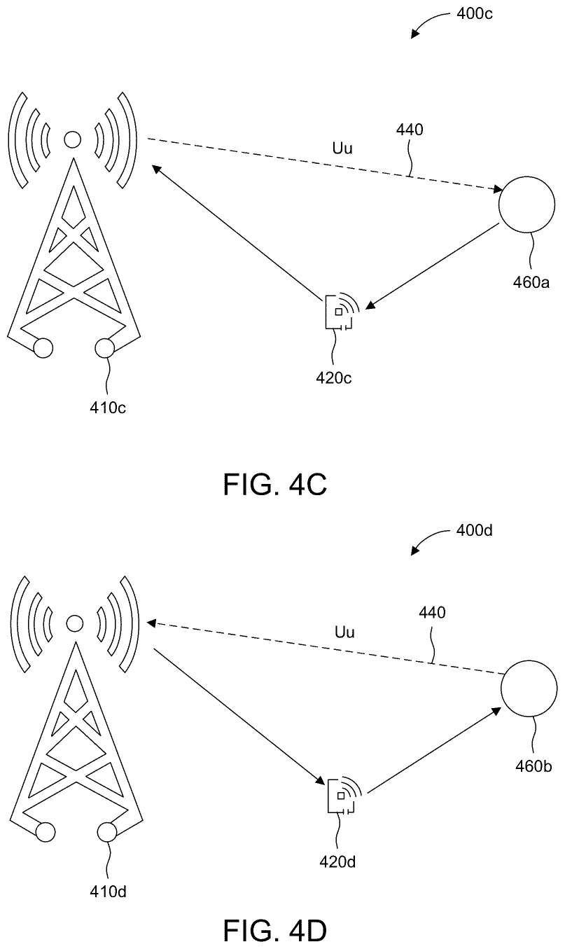

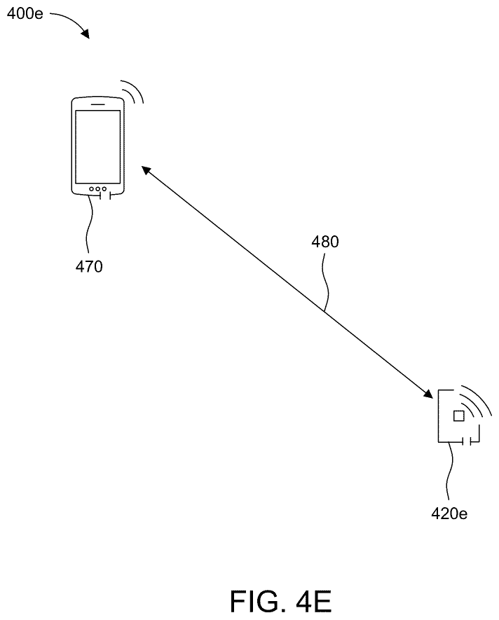

An AIOT system may be based on one of a number of different topologies. Examples of the different topologies are provided in FIGS. 4A, 4B, 4C, 4D and 4E and described in more detail below.

FIG. 4A is a system diagram of an example Topology 1 AIOT system 400a. In Topology 1, and as illustrated in FIG. 4A, an Ambient IoT device 420a may directly and bidirectionally communicate with a base station 410a. The communication between the base station 410a and the ambient IoT device 420a may include AIOT data and/or signaling. In some applications of Topology 1, the base station transmitting to the AIOT device may be a different from the base station receiving from the AIOT device.

FIG. 4B is a system diagram of an example Topology 2 AIOT system 400b. In Topology 2, and as illustrated in FIG. 4B, an AIOT device 420b may communicate bidirectionally with an intermediate node 430 between the AIOT device 420b and the base station 410b. In this topology, the intermediate node 430 can be, for example, a relay, an IAB node, a WTRU, or a repeater that is capable of AIOT. The intermediate node 430 may transfer information between the base station 410b and the AIOT device 420b. The intermediate node 430 may communicate with the base station 410b via a Uu interface 440 and may communicate with the AIOT device using an AIOT link 450.

FIG. 4C is system diagram of an example Topology 3 AIOT system 400c with downlink assistance. In Topology 3 AIOT with downlink assistance, and as illustrated in FIG. 4C, an AIOT device 420c transmits data/signaling to a base station 410c, and receives data/signaling from the assisting node 460a. The base station 410c may communicate directly with the assisting node 460a via a Uu interface 440. In this topology, the assisting node 460a can be, for example, a relay, IAB, WTRU, or repeater, that is capable of AIOT.

FIG. 4D is a system diagram of an example Topology 3 AIOT system 400d with uplink assistance. In Topology 3 with uplink assistance, and as illustrated in FIG. 4D, an AIOT device 420d receives data/signaling from a base station 410d and transmits data/signaling to the assisting node 460b. The base station 410d may communicate directly with the assisting node 460b via a Uu interface 440. In this topology, the assisting node 460b can be, for example, a relay, IAB, WTRU, or repeater that is capable of AIOT.

FIG. 4E is a system diagram of an example Topology 4 AIOT system 400e. In Topology 4, and as illustrated in FIG. 4E, an AIOT device 420e may communicate bidirectionally with a WTRU 470. The communication between the WTRU 470 and the AIOT device 420e may include AIOT data and/or signaling.

While an AIOT Reader, such as the AIOT Reader 304 of FIG. 3, may use the configured periodic resources to send the message 306, it needs to dynamically request resources, such as from an associated base station, both to send the second message 310 and to receive data (e.g., MSG3 312) from the AIOT devices 302. More specifically, in Topology 2, the intermediate node 430 receives resources for AIOT transmission (to AIOT devices) and reception (from AIOT devices). When the intermediate node 430 is in RRC_CONNECTED, the base station can schedule AIOT resources dynamically or by configured grant, much like in Uu or in sidelink (SL).

For scheduling of resources for sidelink and Uu, a WTRU may send a resource request to a base station. This resource request may be or include a buffer status report (BSR), which the WTRU may use to report the amount of data available for transmission in the WTRU's buffers so the base station can schedule an appropriate amount of resources for the data transmission. A BSR can be triggered by certain events, such as availability of new data or data of a higher priority, to keep the network aware of the resources that need to be scheduled. For both sidelink and Uu, the WTRU reports its own buffer status to obtain resources required to transmit data in its own buffers

For AIOT using Topology 2, the network should similarly be aware of the resource needs of the intermediate node so it can schedule an appropriate amount of resources for the data transmission. However, because AIOT is based on inventory and command procedures, there are significant challenges to implementing a BSR procedure for resource scheduling in AIOT. For example, in AIOT Topology 2-based systems, the network can only rely on buffer status information from the intermediate node, but it still needs to allocate resources at the intermediate node to accommodate AIOT device transmissions. Specifically, the network needs to allocate resources for device transmissions without knowledge of the size of such transmissions.

Consider, for example, the example AIOT system 300 of FIG. 3. After the AIOT reader 304 sends the message 306, the AIOT device 302 may send the first message 308 to the AIOT reader 304. Since the AIOT reader 304 needs to request resources to ultimately receive a data transmission from the AIOT device 302 (third message 312), it may not be sufficient for the AIOT reader 304 to simply report the status of its buffer in a BSR as that information would not include the incoming data from the AIOT device.

Additionally, AIOT devices, such as the AIOT device(s) 302 of FIG. 3, are assumed to operate under specific time restrictions. For example, when an AIOT device transmits the first message 308 to an AIOT reader, the corresponding second message 310 should be received within a maximum time period. Similarly, when an AIOT reader transmits the second message 310 to an AIOT device, the corresponding third message 312 should be received within a maximum time period. These time constraints make traditional triggers to transmit a BSR, in the Uu or SL context, insufficient for use to properly scheduling AIOT resources.

Embodiments described herein, therefore, provide for mechanisms that an intermediate node in Topology 2 (also referred to hereinafter as a Reader WTRU) may use to request resources for communicating with AIOT devices. Such mechanisms enable the Reader WTRU to provide the network with information it needs to allocate resources that accounts for both transmissions from the Reader WTRU and transmissions from the AIOT device.

More specifically, in embodiments described herein, a Reader WTRU, such as the Reader WTRU 304 of FIG. 3, may trigger an AIOT-specific BSR when a total number of repetitions of the first message 308 exceeds a configured threshold. The BSR may include, for example, information indicating the number of repetitions of the first message 308 for each AIOT device 302 that transmitted the first message 308 (e.g., after the message 306 was sent or since the last AIOT-specific BSR was sent). The BSR may also include timing information, such as how many configured grant (CG) periods have occurred since the first message 308 was transmitted to the Reader WTRU. The Reader WTRU may be configured with AIOT-link CG resources, such as via RRC signaling from the base station. The WTRU may also be configured, such as via RRC signaling from the base station, with a threshold number of repetitions of the first message (e.g., MSG1 308) for triggering a resource request, such as an AIOT BSR.

The AIOT reader 304/430 may begin an inventory round by transmitting an occasion start message on the AIOT-link 450 CG resource instance. Following the start message transmission, the AIOT reader 304/430 may begin receiving one or more sets of one or more first transmissions (e.g., MSG1 308) from a set of AIOT devices. Each set of the first transmissions may be from a different AIOT device and includes an initial first transmission followed by one or more first transmission repetitions if necessary. Each transmission in a set may include the same random ID associated with the AIOT device that sent it. Each set of first transmissions may, therefore, include a different random ID.

The AIOT Reader 304/430 may then transmit, in an AIOT-link resource other than the CG resource, a second transmission (e.g., MSG2 310), to a subset of the first set of AIOT devices. The subset of AIOT devices may include all, or less than all, of the AIOT devices that sent the first message (e.g., MSG1 308) to the AIOT reader 304/430. The second message 310 may include the random ID received from the AIOT device in the first transmission (e.g., MSG1 308). The AIOT Reader 304/430 may then receive data from the one or more AIOT devices to which the AIOT Reader 304/430 sent the second transmission (e.g., MSG2 310).

The AIOT Reader 304/430 may trigger a resource request based on the received first transmissions, the timing of a Uu grant, or the timing of a next AIOT periodic (e.g., CG) resource. For example, the AIOT Reader 304 may trigger a resource request if the total number of first transmission repetitions received, from AIOT devices in the subset, since the last time the AIOT Reader 304/430 sent a resource request, exceeds the configured threshold. Additionally or alternatively, the AIOT Reader 304/430 may trigger a resource request if the time duration associated with all of the first transmissions, since the last time the AIOT Reader 304/430 sent a resource request, exceeds the configured threshold. The resource request may be a high priority AIOT BSR or Uu BSR, for example. If a Uu grant is not available prior to the next AIOT CG resource, the AIOT Reader 304/430 may trigger Uu SR. An AIOT device may, for example, perform more repetitions of the first transmission (e.g., MSG1 308) if it failed one or more previous inventory procedures, and the network may take this information into account when determining the amount of resources the network needs to allocate for the third message transmissions (e.g., MSG3 312).

An AIOT BSR may include information indicating one or more random IDs associated with the first transmission (e.g., MSG1 308) from the one or more AIOT devices (e.g., the AIOT devices in the subset) and, for each random ID included, the number of repetitions of the first transmission by the AIOT device and/or the number of CG periods that have occurred since the first transmission was received from that device. The information regarding the number of CG periods since the device transmitted the first transmission may be needed by the network to determine how many resources for the second message transmission (e.g., MSG2 310) and the third message transmission (e.g., MSG3 312) to transmit in a CG period to avoid having a specific device waiting too long to send the second transmission (e.g., MSG2 310).

The terms device, AIOT WTRU, and TAG may be used interchangeably herein to mean the AIOT device that is being inventoried/queried by the reader. The term reader refers to the entity that queries the AIOT device, either directly, or via an intermediate WTRU in Topology 2. The term reader in Topology 2 may also refer to the intermediate node, intermediate WTRU, or WTRU. As a result, the term reader may refer to a network node or a WTRU, depending on the context and/or the topology. The terms reader, network, intermediate WTRU, and WTRU may be used interchangeably to mean the reader.

Inventory refers to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID, or perform a random access (RACH) procedure. Specifically, the inventory procedure refers to a set of access occasions which may have 0 or at least 1 device respond within the access occasion. An inventory procedure may occur similar to a legacy RFID procedure. Although referred to herein as an inventory procedure, it may be termed differently in device requirements or specifications (e.g., query procedure, paging procedure, etc.).

Command may be used herein to refer to the overall command procedure triggered by a WTRU (e.g., reader) for one or more devices after an inventory procedure is completed (e.g., RACH procedure and/paging/query procedure). For example, a WTRU may trigger a command procedure for one or more WTRUs after the one or more WTRUs complete the inventory procedure. For example, the WTRU may perform data communication with the device(s) via an AIOT interface during a command procedure. For example, the WTRU may send a command with operation request (e.g., read, write) with one or more devices. For example, a read command allows the WTRU to read (all/a part of/a portion of) device information (e.g., memory, EPC memory, TID memory, etc.). For example, a write command allows the reader to write a word and/or information in a device's memory (e.g., memory, EPC memory, TID memory).

Occasion refers to the opportunity for device transmission that may be delimited by the transmission of a query rep message (or similar). Specifically, a device may perform transmission in an occasion by performing an AIOT transmission in a defined time following the query rep associated with that transmission. Alternatively, an occasion may consist of both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

An AIOT transaction herein may consist of any of an inventory procedure, an inventory+command procedure, a command procedure, or a random access procedure, in the context of AIOT.

Herein, depending on the solution or description, any reference to time can be associated with an absolute time measurement (e.g., seconds, slots, frames, etc.). Alternatively, it can refer to a number of executions of a procedure, which may be triggered by a reader (e.g., number of inventory procedures, number of accesses or RACH procedures, etc.). Alternatively, it can refer to a number of messages, for example of a specific type, or containing specific information, as described herein, received or transmitted.

Configuration or pre-configuration may refer to any configuration received by a message (e.g., an RRC message, a MAC CE, a PHY layer signal, a data PDU, a control PDU associated with any or a new protocol layer, etc.) received from either a network node or from another device or WTRU.

A device herein may be configured by the reader, whereby the reader may be a network node or a WTRU (e.g., intermediate WTRU in Topology 2). In the case of a WTRU, the WTRU may derive the device configuration itself, or receive the device configuration from the network, in which case, the device configuration is being relayed from the network to the device by the WTRU.

On the other hand, a WTRU configuration (in the case of a WTRU in Topology 2) may be received from a network node (e.g., the gNB).

Embodiments described herein refer to a resource request or AIOT resource request. Such resource request may consist of a status report (SR), a new type of buffer status report (BSR), a new type of unused transmission occasion uplink control information (UTO-UCI), a MAC control element (MAC CE), an RRC message, a physical uplink control channel (PUCCH) transmission, or any other Uu transmission initiated by the WTRU and sent to the network. Some of these terms are used interchangeably herein.

In embodiments described herein, a Reader WTRU may be configured with Uu resources to provide the network with control messages that control the AIOT resources. The dedicated resources may be configured separately from the AIOT resources. Alternatively, specific resources within the AIOT resources (e.g., a specific symbol, slot, etc.) may be reserved for signalling to the network. For example, the reader and device may avoid transmission on the reserved resource.

In some embodiments, a resource (e.g., a dedicated SR resource) may be configured to request resources for a part of an AIOT operation. For example, a WTRU may be configured with an SR-like resource after a set of AIOT resources associated with MSG1 transmission in an access occasion. Specifically, each access occasion may have one or more SR resources associated with it. The reader WTRU may use the SR resources to inform the network of the reception of one or more random IDs in the resources set aside for MSG1 transmission. For example, the reader may be configured with an SR resource for all of the MSG1 resources in an access occasion. The reader may send an SR if at least one MSG1 is received. Alternatively, the reader may send an SR if any of the triggers described herein is met. For another example, the reader may be configured with an SR resource for each of the MSG1 resources and may trigger SR if a random ID is received in the corresponding MSG1 resource, in some embodiments only if such random ID is unique with respect to any of the other received MSG1 resources.

In some embodiments, the reader may be configured with a unique SR resource for each range of number of random IDs received, in some embodiments in one or more access occasions. Specifically, an SR resource may be configured (e.g., in RRC signaling) for each range of received random IDs. For example, a first SR resource may be associated with reception of 1-x1 random IDs in the N MSG1 resources, a second SR resource may be associated with reception of x2-x3 random IDs in the N MSG1 resources, etc. The reader may first determine the number of MSG1s received, in some embodiments containing unique random IDs only, and may trigger the SR resource that corresponds to that number of received MSG1s.

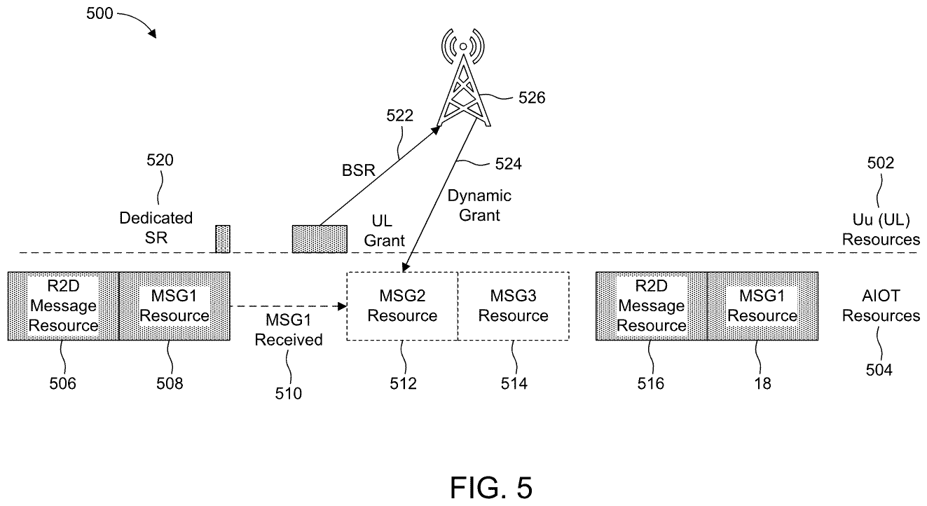

FIG. 5 is an example diagram 500 showing Uu and AIOT resource allocations for an example AIOT inventory round. In the example illustrated in FIG. 5, Uu (UL) resources 502 are shown above the dashed line and AIOT resources 504 are shown below the dashed line. An AIOT Reader may use AIOT resource 506 to send the start message and may receive the first transmission (e.g., MSG1 308) on AIOT resource 508. If a first transmission is received, the AIOT Reader may use a dedicated SR 520 to inform the base station 526. Additionally or alternatively, if any of the conditions described herein for triggering a BSR is met, the AIOT Reader may send a BSR 522 using SR 521 to request resources for the second transmissions (e.g., MSG2 310) and third transmissions (e.g., MSG3 312). The base station 526 may allocate AIOT resource 512 for the second transmission (e.g., MSG2 310) and AIOT resource 514 for the third transmission (e.g., MSG3 312) using a dynamic grant 524. A next inventory round may begin the same way with the AIOT reader using AIOT resource 516 to send the start message and receiving the first transmission (e.g., MSG1 308) using AIOT resource 518.

In some embodiments, an AIOT Reader may be configured with resources to indicate that a previously configured AIOT resource or set of resources is not required. Such resources may be PUCCH-like resources where different information can be signalled in such a resource. Such resource may be configured for each access occasion whereby a set of resources for the second transmission (e.g., MSG2 310) and the third transmission (e.g., MSG3 312) are also associated with each access occasion. Alternatively, there may be one such PUCCH-like resource (and one set of MSG2/MSG3 resources) configured for a number of access occasions.

In some embodiments, a single PUCCH-like resource may be configured and associated with a set of resources configured for MSG2 transmission (and corresponding MSG3 transmission by AIOT devices). If the Reader WTRU does not receive any random IDs in the MSG1 resources, the reader may trigger transmission in the dedicated resource. In some embodiments, multiple PUCCH-like resources may be configured, each associated with a number of MSG3 resource pairs to be removed or which will be unused. Specifically, the WTRU may be configured with a set of resources for MSG3, where each MSG3 resource is allocated (via MSG2) by the AIOT Reader to an AIOT device that transmits MSG1 in an access occasion. The reader may be initially configured with N such MSG3 resources indicating an expected or maximum number of responses. If the reader receives only N-x MSG1 transmissions from devices, the reader may select a corresponding PUCCH-like resource which is configured to indicate that X of the resources will be unused.

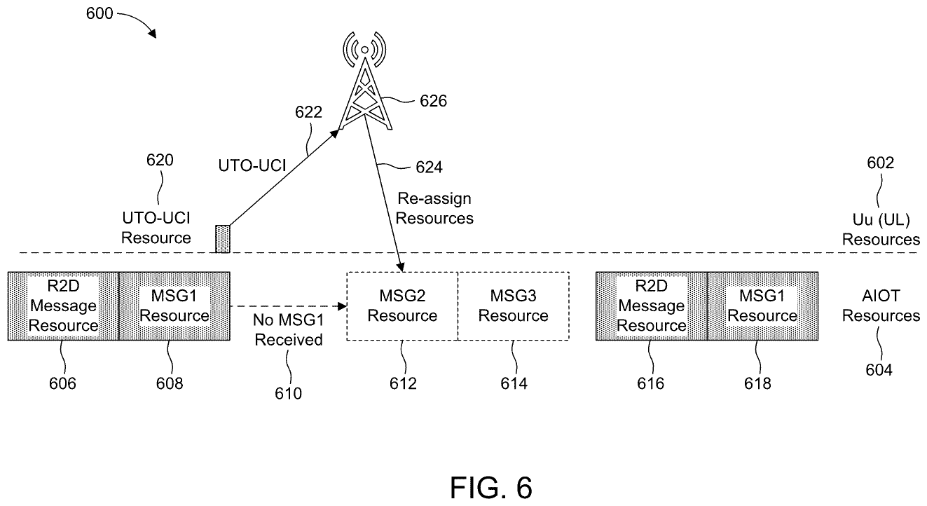

FIG. 6 is a diagram 600 showing Uu and AIOT resource allocations for another example AIOT inventory round. In the example illustrated in FIG. 6, Uu (UL) resources 602 are shown above the dashed line and AIOT resources 604 are shown below the dashed line. Similar to the embodiment illustrated in FIG. 5, in the example illustrated in FIG. 6, an AIOT Reader may use AIOT resource 606 to send the start message and may receive the first message transmission (e.g., MSG1308) on AIOT resource 608. If no first message transmission (e.g., MSG1 308) is received, however, the AIOT Reader may use a UTO-UCI resource 620 to send a UTO-UCI 622 to the base station 626, which may cause the base station 626 to re-assign the resources 624 for use, for example, as MSG2 resources 612 and/or MSG3 resources 614. A next inventory round may begin the same way with the AIOT reader using AIOT resource 616 to send the start message and receiving the first message transmission (e.g., MSG1 308) using AIOT resource 618 (if one or more are sent).

A reader WTRU may be configured with triggers for sending AIOT resource requests. An AIOT-specific SR may be a dedicated SR resource, or any other Uu resource that the reader WTRU may transmit on a Uu PHY channel (i.e., without sending a MAC CE). For example, a WTRU may be configured with a trigger for sending SR. When the WTRU receives a Uu resource, it may send a BSR. Alternatively, the WTRU may be configured with a different trigger (from the ones described below) for triggering SR and for triggering BSR.

A reader WTRU may trigger an AIOT resource request based on one or more of the following events and/or conditions: repetition of a message from a device in an AIOT resource assigned by the reader for the possibility of that reception; non-reception of a message from a device in an AIOT resource assigned by the reader for the possibility of that reception; ability to include a configured set of transmissions into a message or a set of resources; amount of resources in period of time and/or range of frequencies is insufficient; when a pending number of messages to be transmitted reaches a configured value; when a number of AIOT commands reaches a threshold; when a pending number of messages to be transmitted increases/decreases by a certain amount; based on a number of failures; based on the usage of a resource for a particular message; based on time remaining to a specific resource (e.g., a CG occasion); upon transmission of a specific message by the reader (e.g. occasion start message); based on conditions associated with the AIOT device transmission characteristics (i.e., conditions that may result in a different expectation of resources); based on conditions associated with reader transmission characteristics (i.e., conditions that may result in a different expectation of the resources); and based on expiry of a timer started upon transmission/reception of a message. Each of these events/conditions is described in detail below.

Regarding triggering based on reception of a message from a device in an AIOT resource assigned by the reader for the possibility of that reception, in some embodiments the Reader WTRU may trigger BSR upon reception of a message from an AIOT device, such as upon reception of MSG1, upon reception of at least X MSG1s within an occasion or within a configured number of occasions, upon reception of MSG3 from a device, upon reception of a command response by a device, upon reception of MSG1 with a specific device ID, etc. The Reader WTRU may further be configured (e.g., by RRC or as a result of the occurrence of another AIOT event) to trigger BSR upon reception of a message.

Regarding non-reception of a message from a device in an AIOT resource assigned by the reader for the possibility of that reception, in some embodiments, the Reader WTRU may trigger a resource request if it does not receive a specific message, such as in a resource or set of resources, for example, upon not receiving any MSG1 transmissions in an occasion or over multiple (a number of configured) occasions, upon not receiving MSG3 from a device following transmission of MSG2 indicating that AIOT device, or upon not receiving a response from a transmitted command.

Regarding triggering based on the ability to include a configured set of transmissions into a message or a set of resources, in some embodiments a Reader WTRU may trigger a resource request upon the inability to include an expected/configured set of information, or to perform a configured set or number of transmissions in a resource or set of resources. For example, the Reader WTRU may trigger a resource request if the number of random IDs that can be included in MSG2 is below a threshold. For example, the WTRU may trigger a resource request if it is unable to include all random IDs in MSG2 that are associated with a configured condition (e.g., a condition associated with the transmission of MSG1). For example, the WTRU may trigger a resource request if there are insufficient resources for MSG3 and as a result, the Reader WTRU does not include all random IDs in MSG2.

Regarding triggering when the amount of resources in period of time and/or range of frequencies is insufficient, in some embodiments, a WTRU may trigger BSR when the amount of resources in a time period and/or range of frequencies is considered insufficient. A measure of insufficiency may be based on a configured quantity of resources or a required amount of resources. For example, the network may configure a threshold number of available resources per configured or determined time period and/or frequency range. If the number of resources available for AIOT operation in the configured period/frequency range falls below a threshold, the Reader WTRU may trigger an AIOT resource request. For another example, the Reader WTRU may estimate the amount of resources required to handle all pending transmissions by the Reader WTRU and/or expected transmissions by the devices. For example, the Reader WTRU may assign a pre-configured or configured amount of resources to each expected MSG3 resource, MSG2 resource, command operation, etc. For example, the Reader WTRU may determine the resources required for the command operation based on indication, from the network, of the size of the response from the device. For example, the Reader WTRU may assign a fixed amount of resources for MSG3 transmission. For example, the Reader WTRU may determine the number of MSG3 resources based on the number of MSG1 resources received at a given time. The Reader WTRU may maintain a measure of the amount of resources required for the pending transmissions, such as over a fixed or configured time period. If the amount of resources is insufficient for this required amount, the Reader WTRU may trigger a resource request. For example, a Reader WTRU may monitor the number of frequency resources required in a slot considering devices operating in FDM. If the number of frequency resources in a slot, in a set of time resources, or in a time window, is insufficient to allow the devices expected to transmit to transmit, the Reader WTRU may trigger a resource request.

Regarding triggering when a pending number of messages to be transmitted reaches a configured value, in some embodiments, a Reader WTRU may trigger a resource request when a pending number of messages to transmit, or a number of unhandled messages received, reaches a threshold. For example, the Reader WTRU may receive MSG1 transmissions from multiple devices in one or more access occasions. The Reader WTRU may respond to MSG1 transmissions with MSG2, such as where a single MSG2 contains multiple/all random IDs in MSG1. The Reader WTRU may transmit such a response upon reception of an appropriate resource from the network (e.g., a grant that is large enough, a grant that is associated with appropriate MSG3 resources, a grant that is explicitly indicated to be used for MSG2 transmission, etc.). If the number of received MSG1 random IDs that have yet to be handled by a MSG2 response exceeds a threshold, the Reader WTRU may trigger a resource request.

Regarding triggering when a number of AIOT commands reaches a threshold, in some embodiments, a Reader WTRU may trigger a resource request when it receives, from the network or from upper layers, at least a threshold number of commands to be transmitted. In some embodiments, a Reader WTRU may trigger a resource request when the number of commands that have been received but have yet to be transmitted is larger than a threshold.

Regarding triggering when a pending number of messages to be transmitted increases/decreases by a certain amount, in some embodiments, a Reader WTRU may trigger a resource request when a pending number of messages increases or decreases by a certain amount, such as a result of a specific event, or between specific events (e.g., from the time of transmission of one occasion start message to the next occasion start message), where the pending number of messages is defined above.

Regarding triggering based on a number of failures, in some embodiments, a Reader WTRU may trigger a resource request when a failure occurs on the AIOT interface. A failure may occur where: a Reader WTRU is unable to receive or decode one or more or a configured number of MSG3 transmissions from devices, a Reader WTRU detects one or more or a configured number of conflicting random numbers in MSG1 (i.e., the same random number received in separate occasions or MSG1 resources, and therefore transmitted by different devices), and/or a Reader WTRU determines to trigger one or more or a configured number of re-access indications to an AIOT device.

Regarding triggering based on the usage of a resource for a particular message, in some embodiments, a Reader WTRU may trigger a resource request if it uses resources for a specific type of AIOT transmission. For example, a resource (e.g., a CG grant) may be configured for transmission of an occasion start message and/or MSG1. The Reader WTRU may trigger a resource request if the resource, or any transmission occasion of the resource, is used for transmission of another message (e.g., command, MSG3, etc.).

Regarding triggering based on time remaining to a specific resource (e.g., a CG occasion), in some embodiments, a Reader WTRU may trigger a resource request, which may be in combination with another condition, when the time remaining to a specific resource (e.g., a CG transmission occasion) is less than a threshold. For example, if the number of pending transmissions reaches a first threshold, the Reader WTRU may trigger the resource request only when the time remaining until the specific resource is less than a second threshold while the pending messages remains above the first threshold. For another example, the Reader WTRU may be configured with a trigger occasion start number (e.g., if the entire inventory procedure is N occasions, the trigger occasion may be the kth occasion). The Reader WTRU may further be configured to trigger a resource request if any of the conditions herein occurs before the kth occasion, has occurred before the kth occasion, has occurred before the kth occasion and was not resolved by the kth occasion, etc. For another example, the Reader WTRU may be configured to trigger a resource request at, or some configured time prior to, the start of a set of configured occasions (e.g., all even numbered occasions).

Regarding triggering upon transmission of a specific message by the reader (e.g. occasion start message), in some embodiments, a Reader WTRU may trigger a resource request upon transmission of a specific message. For example, the WTRU may trigger a resource request upon transmission of an occasion start message, upon transmission of a configured set of occasion start messages, upon transmission of a command, and/or upon transmission of MSG2.

Regarding triggering based on conditions associated with the device transmission characteristics (i.e., conditions that may result in a different expectation of resources), in some embodiments, a Reader WTRU may trigger a resource request upon reception of an indication from a device transmission, or based on device transmission characteristics. For example, the Reader WTRU may trigger a resource request based on the RSRP of the device transmission meeting some configured condition, based on the number of repetitions of a device transmission meeting some configured condition, based on the length of a device transmission meeting a configured condition, based on the inclusion, by the device, of data in its transmission (e.g., data with MSG 1 for 2-step RACH), and/or based on the reception of an energy status from a device.

Regarding trigger based on conditions associated with reader transmission characteristics (i.e., conditions that may result in a different expectation of the resources), in some embodiments, a Reader WTRU may trigger a resource request upon determination of a condition associated with its own transmission characteristic. For example, a Reader WTRU may determine a transmit power, a number of repetitions, a transmission duration, etc. for its own transmission based on information derived by a device's transmission and/or information from the network. The Reader WTRU may then be configured with a condition based on the transmission characteristics in which BSR is triggered. For example, the Reader WTRU may be configured with a condition based on the power of the reader transmission meeting some configured condition, based on the number of repetitions of the reader transmission meeting some configured condition, based on the length of a reader transmission meeting a configured condition, and/or based on the reader determining to use a specific RACH type (e.g., 2-step RACH).

Regarding triggering based on expiry of a timer started upon transmission/reception of a message, in some embodiments, a Reader WTRU may trigger a resource request upon expiry of a timer, whereby such timer may be started upon reception of a message from a device.

A Reader WTRU may transmit a resource request on Uu as a MAC CE (e.g., AIOT BSR). The Reader WTRU may determine a priority of the MAC CE in LCP. Specifically, the Reader WTRU may determine whether to prioritize the AIOT BSR over Uu data and/or other MAC CEs. A reader may determine such priority based on: the amount of CG resources allocated to the Reader WTRU, the contents carried by the AIOT BSR, based on the time remaining to a resource (e.g., the next CG resource), based on the time following transmission/reception of a message, based on the CG resource time spacing, and/or based on the time between the start of AIOT occasions.

Regarding the Reader WTRU determining whether to prioritize the AIOT BSR over Uu data and/or other MAC CEs based on the amount of CG resources allocated to the Reader WTRU, for example, if the amount of time frequency CG resources allocated for AIOT transmissions is larger than a threshold, the AIOT BSR may have low priority, otherwise, it may have high priority.

Regarding the Reader WTRU determining whether to prioritize the AIOT BSR over Uu data and/or other MAC CEs based on the contents carried by the AIOT BSR, for example, the AIOT BSR may carry different contents or information, depending on the status of an inventory procedure. The AIOT BSR may be given different priorities depending on this content. For example, when the BSR contains information related to an AIOT device from which MSG3 was not received, it may have higher priority than when the BSR contains information related to received devices for which MSG1 was received.

Regarding the Reader WTRU determining whether to prioritize the AIOT BSR over Uu data and/or other MAC CEs based on the time remaining to a resource (e.g., the next CG resource), for example, if the time remaining until the next CG resources is below a threshold, the AIOT BSR may have high priority, otherwise, it may have low priority.

Regarding the Reader WTRU determining whether to prioritize the AIOT BSR over Uu data and/or other MAC CEs based on the time following transmission/reception of a message, for example, if the time elapsed since the reception or transmission of an AIOT message by the reader is below a threshold, the AIOT BSR may have a low priority, otherwise, it may have a high priority.

Regarding the Reader WTRU determining whether to prioritize the AIOT BSR over Uu data and/or other MAC CEs based on the CG resource time spacing, for example, the priority may be configured as a function of the CG resource time spacing. For example, if the time between CG resources is above a threshold, the AIOT BSR may have low priority, otherwise it may have high priority.

Regarding the Reader WTRU determining whether to prioritize the AIOT BSR over Uu data and/or other MAC CEs based on the time between the start of AIOT occasions, for example, the priority may be configured as a function of the time between the start of successive inventory occasions. If the time between inventory occasions is above a threshold the AIOT BSR may have low priority, otherwise, the AIOT BSR may have high priority.

A Reader WTRU may include information in the AIOT BSR or resource request that is specific to the AIOT operation. In some embodiments, the AIOT BSR triggered to request resources for MSG2 and/or MSG3 may contain a number of MSG1 random IDs received, for example, in the last access occasion, in each frequency resource or location, over a configured time period (e.g., number of slots), since the time MSG2 was transmitted by the reader, or since the last time the BSR was transmitted. In some embodiments, the number of MSG1 transmissions received that would still need to be responded to by the Reader WTRU, which may, in some embodiments, not include the MSG1 transmissions the reader does not intend to respond to or has already triggered re-access for.

In some embodiments, the AIOT BSR triggered to request resources for MSG2 and/or MSG3 may contain the random IDs received along with specific information related to MSG1 for each random ID, such as: the time elapsed since MSG1 was received with that random ID, a resource index associated with the resource in which that random ID was received, whether data was received along with MSG1 (i.e. 2-step RACH) or not for that specific random ID, whether an energy status indication was received along with MSG1 for that specific random ID or not, or transmission characteristics associated with the MSG1 transmission for that specific random ID, such as received power, number of repetitions, indication of re-access or initial access, and/or transmission length.

In some embodiments, an AIOT BSR triggered to request resources for MSG2 and/or MSG3 may contain an estimate of the required resources. For example, the Reader WTRU may provide the number of required subresources, where each subresource may be used for transmission of MSG3 by one device. For example, the Reader WTRU may determine a size of each subresource (e.g., based on the required encoding, required transmission length, required number of repetitions, etc.) estimated for each subresource. The Reader WTRU may estimate such size based on transmission parameters associated with the received MSG1. The Reader WTRU may then include, in the BSR: a number of subresources of each configured size or size range, a size associated with each MSG3 resource, and/or a number of subresources for which the size is larger than a threshold.

In some embodiments, the AIOT BSR triggered to request resources for an AIOT command may contain the expected response message size or an indication that the Reader WTRU has not received an expected response message size.

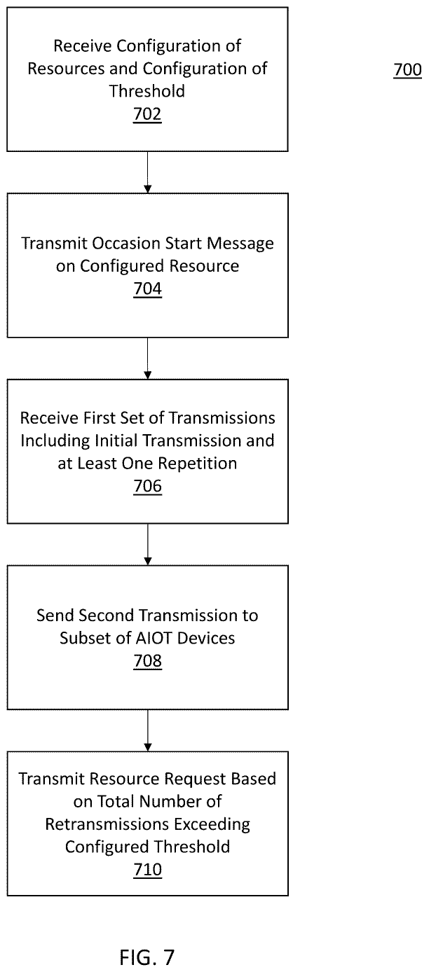

FIG. 7 is a flow diagram of an example method of requesting resources for AIOT transmissions. A Reader WTRU may receive a configuration of resources and a configuration of a threshold (702). The configuration may be received from a base station. The configuration of resources may include a configuration of periodioc resources for transmissions with AIOT devices. The Reader WTRU may transmit an occasion start message on a configured resource (704), which may be received by one or more of the AIOT devices. The Reader WTRU may receive a first set of transmissions (706) from each of a set of AIOT devices. The first set of transmissions may be sent in response to the occasion start message. The first set of transmissions may include an initial transmission and at least one repetition of the initial transmission from the same AIOT device. The Reader WTRU may then send a second transmission to a subset of the set of AIOT devices (708). The Reader WTRU may transmit a resource request (710), to the base station based on a total number of all repetitions of the first transmission from all of the AIOT devices in the subset, since a last transmission of a resource request from the WTRU, exceeding the configured threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a transceiver; and
a processor,
wherein the transceiver and the processor are configured to receive a configuration, from a base station, of periodic resources for transmissions with ambient-internet-of-things (AIOT) devices and a configuration for a threshold,
wherein the transceiver and the processor are further configured to transmit an occasion start message, to the AIOT devices, on one of the periodic resources,
wherein the transceiver and the processor are further configured to receive, in response to the occasion start message, a first set of transmissions from each AIOT device in a set of AIOT devices, wherein the first set of transmissions comprises an initial transmission and at least one repetition of the initial transmission from the same AIOT device,
wherein the transceiver and the processor are further configured to send a second transmission to a subset of the set of AIOT devices, and
wherein the transceiver and the processor are further configured to transmit a resource request, to the base station, based on a total number of all repetitions of the first transmission from all of the AIOT devices in the subset, since a last transmission of a resource request from the WTRU, exceeding the configured threshold.

2. The WTRU of claim 1, wherein the configuration of the periodic resources and the configuration for the threshold are received from the base station via radio resource control (RRC) signaling.

3. The WTRU of claim 1, wherein the initial transmission and the at least one repetition of the initial transmission from the same AIOT device comprises an indication of the same random identifier associated with the AIOT device that sent the first set of transmissions.

4. The WTRU of claim 3, wherein the second transmission includes the random identifier of the AIOT device that sent the first set of transmissions.

5. The WTRU of claim 4, wherein the resource request comprises information indicating the random identifier of each AIOT device in the subset.

6. The WTRU of claim 4, wherein the resource request comprises information indicating a number of repetitions in the first set of transmissions from each identified AIOT device.

7. The WTRU of claim 4, wherein the resource request comprises an indication of a number of configured grant periods since the initial transmission was received from each identified AIOT device.

8. The WTRU of claim 1, wherein the transceiver and the processor are further configured to receive a data transmission, following the second transmission, from each of the AIOT devices in the subset.

9. The WTRU of claim 1, wherein the resource request is one of a high priority AIOT buffer status report (BSR) or a Uu status report (SR).

10. The WTRU of claim 1, wherein, for a pending uplink grant, the WTRU is further configured to transmit the resource request followed by any data up to a size of the pending uplink grant.

11. A method, implemented in a wireless transmit/receive unit (WTRU), the method comprising:
receiving a configuration, from a base station, of periodic resources for transmissions with ambient-internet-of-things (AIOT) devices and a configuration for a threshold;
transmitting an occasion start message, to the AIOT devices, on one of the periodic resources;
receiving, in response to the occasion start message, a first set of transmissions from each AIOT device in a set of AIOT devices, wherein the first set of transmissions comprises an initial transmission and at least one repetition of the initial transmission from the same AIOT device;
sending a second transmission to a subset of the set of AIOT devices; and
transmitting a resource request, to the base station, based on a total number of all repetitions of the first transmission from all of the AIOT devices in the subset, since a last transmission of a resource request from the WTRU, exceeding the configured threshold.

12. The method of claim 11, wherein the configuration of the periodic resources and the configuration for the threshold are received from the base station via radio resource control (RRC) signaling.

13. The method of claim 11, wherein the initial transmission and the at least one repetition of the initial transmission from the same AIOT device comprises an indication of the same random identifier associated with the AIOT device that sent the first set of transmissions.

14. The method of claim 13, wherein the second transmission includes the random identifier of the AIOT device that sent the first set of transmissions.

15. The method of claim 14, wherein the resource request comprises information indicating the random identifier of each AIOT device in the subset.

16. The method of claim 14, wherein the resource request comprises information indicating a number of repetitions in the first set of transmissions from each identified AIOT device.

17. The method of claim 14, wherein the resource request comprises an indication of a number of configured grant periods since the initial transmission was received from each identified AIOT device.

18. The method of claim 11, further comprising receiving a data transmission, following the second transmission, from each of the AIOT devices in the subset.

19. The method of claim 11, wherein the resource request is one of a high priority AIOT buffer status report (BSR) or a Uu status report (SR).

20. The method of claim 11, further comprising, for a pending uplink grant, transmitting the resource request followed by any data up to a size of the pending uplink grant.
